(19) United States
(12) Patent Application Publication
(10) Pub. No.: US 2006/0108763 A1
(43) Pub. Date: May 25, 2006

(54) Suspension control arm assembly for vehicles

(76) Inventor: Michael A. Ray, Sterling Hts., MI (US)

Correspondence Address: LAURA C. HARGITT;General Motors Corporation, Legal Staff, Mail Code 482-C23-B21, P.O. Box 300, Detroit, MI, 48265-3000, US

(21) Appl. No.: 11/053,988

(22) Filed: Feb. 8, 2005

Related U.S. Application Data
(60) Provisional application No. 60/630,586, filed on Nov. 23, 2004.

(51) Int. Cl. B60G 7/00

(52) U.S. Cl. 280/124.136; 280/124.125

(57) ABSTRACT

A control arm assembly for a suspension system of a vehicle includes a one-piece extruded control arm for operative connection to a frame of the vehicle. The control arm assembly also includes at least one of a bushing and/or balljoint connected to the control arm and for connection to structure of the vehicle.

### CROSS-REFERENCE TO RELATED APPLICATION(S)

The present application claims the benefit of copending U.S. Provisional Patent Application Ser. No. 60/630,586, filed Nov. 23, 2004.

### TECHNICAL FIELD

The present invention relates generally to suspension systems for vehicles and, more particularly, to a control arm assembly for a suspension system of a vehicle.

### BACKGROUND OF THE INVENTION

It is known to provide a suspension system for a vehicle. In a vehicle such as an automotive vehicle, the suspension system typically includes a pair of control arms supported on a side rail of a vehicle frame for vertical pivotal movement and a steering knuckle connected to the outboard ends of the control arms for vertical suspension excursions. The suspension system typically includes a spring disposed between the frame and the lower control arm.

One typical control arm is formed by casting or by forging. However, castings require molds that are relatively expensive and have to be of a size large enough to prevent ductile bending. Forgings require large presses that are not efficient in the use of raw materials and are expensive. Another typical control arm is formed by a plurality of steel stampings, usually five or six, which are welded together to form the control arm. Control arms formed of a plurality of stampings are expensive and difficult to manufacture. Further, these control arms require bushings/balljoints to be attached to the steel fabrication or aluminum casting.

Therefore, it is desirable to provide a new control arm assembly for a suspension system of a vehicle that eliminates casting, forging, or stamping. It is also desirable to provide a control arm assembly for a suspension system of a vehicle that is made of a relatively light weight material that has less mass than steel. It is further desirable to provide a control arm assembly for a suspension system of a vehicle that utilizes a one-piece control arm. Thus, there is a need in the art to provide a control arm assembly for a suspension system of a vehicle that meets these desires.

### SUMMARY OF THE INVENTION

It is, therefore, one object of the present invention to provide a new control arm assembly for a suspension system of a vehicle.

It is another object of the present invention to provide a new control arm assembly for a suspension system of a vehicle having a control arm that is extruded.

To achieve the foregoing objects, the present invention is a control arm assembly for a suspension system of a vehicle. The control arm assembly includes a one-piece extruded control arm for operative connection to a frame of the vehicle. The control arm assembly also includes at least one of a bushing and/or balljoint connected to the control arm and for connection to structure of the vehicle.

One advantage of the present invention is that a new control arm assembly is provided for a suspension system of a vehicle. Another advantage of the present invention is that the control arm assembly incorporates a control arm that is manufactured from a single piece of extruded aluminum to which bushings and/or balljoint(s) are added. Yet another advantage of the present invention is that the control arm assembly incorporates an aluminum control arm that has less mass that a steel control arm. Still another advantage of the present invention is that the control arm assembly has an extruded aluminum control arm that is less expensive than a cast aluminum control arm due to the cost of extrusion dies versus casting molds. A further advantage of the present invention is that the control arm assembly has an aluminum control arm made of aluminum alloys that are extruded and have sufficient ductility to allow for ductile bending/buckling. Yet a further advantage of the present invention is that the control arm assembly includes a one-piece or single piece control arm that reduces piece count and number of components that are required to be fastened together through bolting, riveting, welding, or other fastening mechanisms.

Other objects, features, and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a perspective view of a control arm assembly, according to the present invention, illustrated in operational relationship with a suspension system of a vehicle.

FIG. 2 is a plan view of the control arm assembly of FIG. 1.

FIG. 3 is a front elevational view of the control arm assembly of FIG. 1.

FIG. 4 is a right side elevational view of the control arm assembly of FIG. 1.

FIG. 5 is a left side elevational view of the control arm assembly of FIG. 1.

### DESCRIPTION OF THE PREFERRED EMBODIMENT

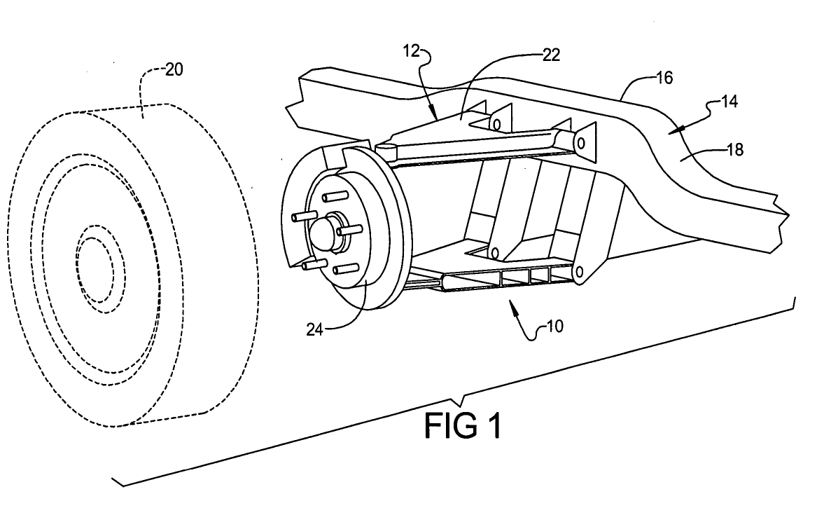

Referring to the drawings and in particular FIG. 1, one embodiment of a control arm assembly 10, according to the present invention, is shown for a suspension system, generally indicated at 12, of a vehicle, such as a motor vehicle (partially shown), generally indicated at 14. The vehicle 14 includes a frame 16 having at least one, preferably a pair of side rails 18 (only one illustrated) generally parallel to a longitudinal centerline of the frame 16 and a rigid cross member (not shown) between the side rails 18. The vehicle 14 also includes at least one, preferably a plurality of wheels 20 connected to the suspension system 12 to suspend the frame 16 relative to the wheels 20.

The suspension system 12 includes an upper control, arm assembly 22 and the lower control arm assembly 10 supported on the side rail 18 for vertical pivotal movement and a steering knuckle (not shown) connected to the outboard ends of the control arm assemblies 20,10 for vertical suspension excursions and for pivotal movement about a steering axis. The wheel 20 is rigidly connected to a hub or rotor 24 rotatably supported on the steering knuckle. The suspension system 12 may include a strut (not shown) and a spring (not shown) disposed between the lower control arm assembly 10 and the frame 16. It should be appreciated that the strut and spring are optional. It should also be appreciated that, in the case of a MacPherson strut type suspension, the spring and strut are attached directly to the steering knuckle and not to the lower control arm assembly 10. It should further be appreciated that the suspension system on the right side (not shown) of the frame 16 is a mirror image of the suspension system on the left side of the frame 16. It should yet, further be appreciated that the control arm assembly 10 is illustrated on a rear suspension system but could be used on a front suspension system. It should still further be appreciated that, except for the control arm assembly 10, the suspension system 12 is conventional and known in the art.

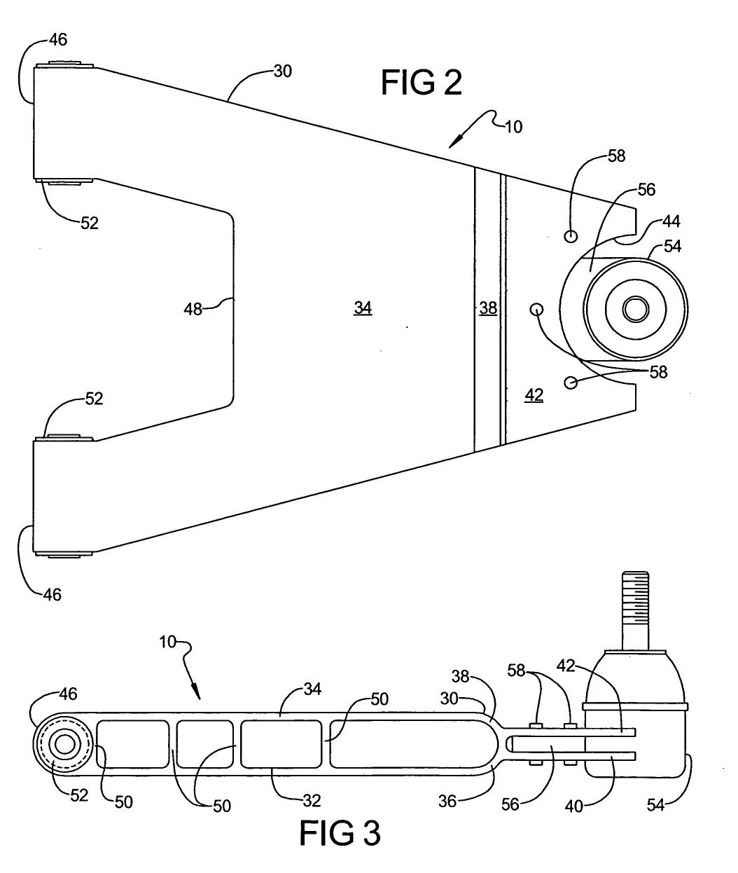

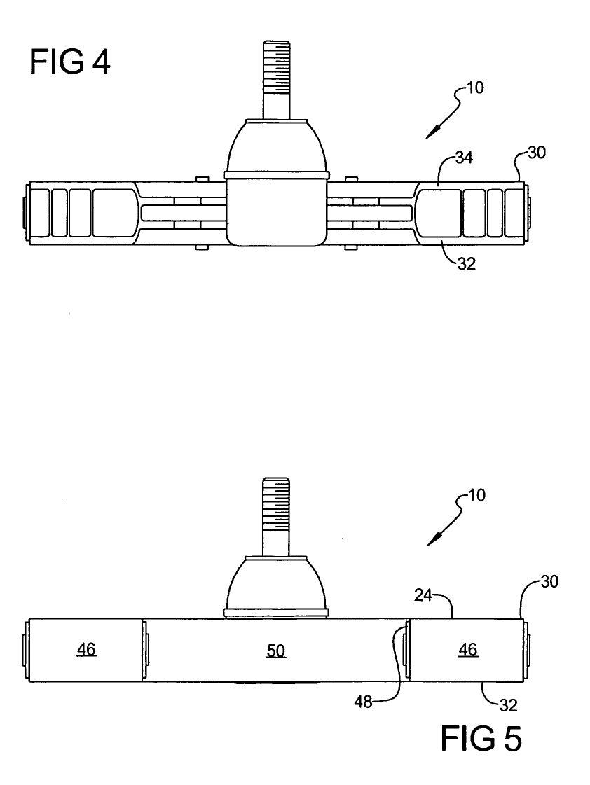

Referring to FIGS. 2 through 5 and describing only one of the control arm assemblies 10, according to the present invention, the control arm assembly 10 includes a control arm 30 formed as a single piece extrusion. The control arm 30 has a lower wall 32 and an upper wall 34 spaced from the lower wall 32. The lower wall 32 and upper wall 34 extend laterally and have a generally “A” shape. The lower wall 32 and upper wall 34 are generally planar and have an end portion 36 and 38, respectively, at one end extending toward each other. The lower wall 32 and upper wall 34 have an end portion 40 and 42, respectively, at one end of the stepped portion 36 and 38, respectively. Each of the end portions 40 and 42 has a recess 44 extending laterally inwardly. The recess 44 is generally arcuate in shape.

The control arm 30 has an end wall 46 connecting one end of the lower wall 32 and upper wall 34 together. The end wall 46 is generally arcuate in shape. The control arm 30 also has a recess 48 extending laterally inward into the end wall 46 and lower wall 32 and upper wall 34. The recess 48 is generally trapezoidal in shape. The control arm 30 has at least one, preferably a plurality of ribs 50 extending longitudinally and vertically between the lower wall 32 and the upper wall 34. The ribs 50 are connected to the lower wall 32 and upper wall 34. The control arm 30 is made of lightweight metal material, preferably aluminum. The control arm 30 is extruded and formed as a monolithic structure being integral, unitary, and one-piece. It should be appreciated that the control arm 30 is a single piece aluminum extrusion that is “universal” such that it may be used for a left or right control arm.

The control arm assembly 10 also includes at least one, preferably a plurality of, more preferably a pair of bushings 52 attached to the control arm 30 at one end thereof. Each of the bushings 52 is generally tubular in shape. Each of the bushings 52 extends longitudinally and has a generally circular cross-sectional shape. Each of the bushings 52 is disposed between the lower wall 32 and upper wall 34 of the control arm 30 between the end wall 46 and one of the ribs 50. Each bushing 52 may include a plurality of linear splines (not shown) projecting radially therefrom. The linear splines are resiliently compressed radially between the lower wall 32, upper wall 34, end wall 46, and rib 50 of the control arm 30. The bushing 52 is made of an elastomeric material. It should be appreciated that the bushing 52 is conventional and known in the art.

The control arm assembly 10 further includes at least one balljoint 54 attached to the control arm 30 at one end thereof opposite the bushings 52. The balljoint 54 is disposed in the recess 44 of the end portions 40,42 of the control arm 30. The balljoint 54 has a flange 56 extending laterally and disposed between the end portions 40,42. The flange 56 is secured to the control arm 30 by suitable means such fasteners 58. The fasteners 58 are preferably rivets, but may be of other suitable type such as bolts. In another embodiment, the balljoint 54 may be secured between the end portions 40,42 by a press fit. Each of the fasteners 58 extends through the lower wall 32 and upper wall 34 in the end portions thereof 40,42. It should be appreciated that the balljoint 54 is conventional and known in the art.

To manufacture the control arm assembly 10, the control arm 30 is extruded as a single piece aluminum extrusion. The shape/dimension of the control arm 30 may allow the aluminum extrusion to be a “universal” control arm, such that the same extrusion can be used for a left or right control arm or the extrusion may be large enough such that a left and right control arm are contained in the extruded shape and separated by a cutting or machine operation. The aluminum extrusion is cut/machined to final dimensions. After final machining, bushings 52 and/or balljoint(s) 54 are attached to the control arm 30 by fasteners 58 to complete the control arm assembly 10.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

1. A control arm assembly for a suspension system of a vehicle comprising:
a one-piece extruded control arm for operative connection to a frame of the vehicle; and
at least one of a bushing and balljoint connected to said control arm and for connection to structure of the vehicle.

2. A control arm assembly as set forth in claim 1 wherein said control arm comprises a lower wall and an upper wall spaced from said lower wall.

3. A control arm assembly as set forth in claim 2 wherein said control arm comprises an end wall interconnecting one end of said lower wall and said upper wall.

4. A control arm assembly as set forth in claim 3 wherein said control arm has a recess extending laterally inward into said end wall and said lower wall and said upper wall.

5. A control arm assembly as set forth in claim 2 wherein said control arm has at least one rib extending longitudinally and vertically between said lower wall and said upper wall.

6. A control arm assembly as set forth in claim 2 wherein said lower wall and said upper wall each have a stepped portion at one end extending toward each other.

7. A control arm assembly as set forth in claim 6 wherein said lower wall and said upper wall have an end portion at one end of said stepped portion with a recess extending laterally inwardly to receive said at least one balljoint.

8. A control arm assembly as set forth in claim 2 wherein said lower wall and said upper wall have a general “A” shape.

9. A control arm assembly as set forth in claim 1 wherein said control arm is a monolithic structure being integral, unitary, and one-piece.

10. A control arm assembly as set forth in claim 1 wherein said control arm is made of a lightweight metal material.

11. A suspension system for a vehicle comprising:
an upper control arm for operative connection to a frame of the vehicle;
a one-piece extruded lower control arm spaced from said upper control arm for operative connection to the frame of the vehicle;
at least one bushing connected to said lower control arm and for operative connection to the frame; and
at least one balljoint connected to said lower control arm and for connection to a steering knuckle of the vehicle.

12. A suspension system as set forth in claim 11 wherein said control arm comprises a lower wall and an upper wall spaced from said lower wall.

13. A suspension system as set forth in claim 12 wherein said control arm comprises an end wall interconnecting one end of said lower wall and said upper wall.

14. A suspension system as set forth in claim 12 wherein said control arm has a recess extending laterally inward into said end wall and said lower wall and said upper wall.

15. A suspension system as set forth in claim 12 wherein said control arm has at least one rib extending longitudinally and vertically between said lower wall and said upper wall.

16. A suspension system as set forth in claim 12 wherein said lower wall and said upper wall each have a stepped portion at one end extending toward each other.

17. A suspension system as set forth in claim 16 wherein said lower wall and said upper wall have an end portion at one end of said stepped portion with a recess extending laterally inwardly to receive said at least one balljoint.

18. A suspension system as set forth in claim 13 wherein said control arm includes a rib extending between said upper wall and said lower wall and defining a space between said end wall and said upper wall and said lower wall to receive said at least one bushing.

19. A suspension system as set forth in claim 11 wherein said control arm is made of a lightweight metal material.

20. A vehicle comprising:
a frame;
at least one wheel;
a suspension system connected to said frame and said at least one wheel;
said suspension system comprising an upper control arm operatively connected to said frame and said at least one wheel;
a one-piece extruded lower control arm operatively connected to said frame and said at least one wheel;
at least one of a bushing connected to said lower control arm and said frame; and
at least one balljoint connected to said lower control arm and said at least one wheel.
